(19) United States
(12) Patent Application Publication
(10) Pub. No.: US 2014/0103625 A1
(43) Pub. Date: Apr. 17, 2014

(54) PARACHUTE AIRBAG DIFFUSER

(71) Applicants: GM Global Technology Operations LLC, Detroit, MI (US); TK Holdings Inc., Auburn Hills, MI (US)

(72) Inventors: SCOTT D. THOMAS, NOVI, MI (US); RICHARD WIIK, FORT GRATIOT, MI (US); NICOLE WIGGINS, SOUTHFIELD, MI (US)

(73) Assignees: TK Holdings Inc., Auburn Hills, MI (US); GM Global Technology Operations LLC, Detroit, MI (US)

(21) Appl. No.: 14/039,766

(22) Filed: Sep. 27, 2013

Related U.S. Application Data
(60) Provisional application No. 61/714,053, filed on Oct. 15, 2012.

(51) Int. Cl. B60R 21/261; B60R 21/207

(52) U.S. Cl. CPC B60R 21/261; B60R 21/207
USPC 280/730.2; 280/740; 280/742

(57) ABSTRACT

One variation may include a product including an airbag diffuser that may be elongated and may be constructed and arranged to provide a gas catcher constructed and arranged to maintain the diffuser in an extended position when hot gases from an inflator impinge on the gas catcher.

### CROSS-REFERENCE TO RELATED APPLICATIONS

This application claims the benefit of U.S. Provisional Application No. 61/714,053 filed on Oct. 15, 2012.

### TECHNICAL FIELD

The field to which the disclosure generally relates to includes airbag diffusers, products including the same and methods of making and using the same.

### BACKGROUND

Airbags may be utilized in vehicles to protect occupants.

### SUMMARY OF ILLUSTRATIVE VARIATIONS

One variation may include a product including an airbag diffuser that may be elongated and may be constructed and arranged to provide a gas catcher constructed and arranged to maintain the diffuser in an extended position when hot gases from an inflator impinge on the gas catcher.

Other variations will become apparent from the detailed description provided hereafter. It should be understood that the detailed description and specific examples, while disclosing select variations of the invention, are intended for purposes of illustration only and are not intended to limit the scope of the invention.

### BRIEF DESCRIPTION OF THE DRAWINGS

Select examples of variations will become more fully understood from the detailed description and the accompanying drawings, wherein:

FIG. 1 illustrates a parachute airbag diffuser according to a number of variations.

FIG. 2 illustrates an airbag diffuser including a gas catcher positioned along one side of the diffuser body including first and second through holes according to a number of variations.

FIG. 3 illustrates an airbag diffuser including a gas catcher having a first closed side and a first through hole according to a number of variations.

FIG. 4 illustrates an airbag diffuser including a gas catcher having a first closed side aligned with an opposite side of the diffuser and including a first through hole according to a number of variations.

FIG. 5 illustrates an airbag diffuser including a gas catcher aligned with another side of the diffuser body portion wherein the diffuser includes first and second through holes defined therein according to a number of variations.

FIG. 6 illustrates an airbag diffuser according to a number of variations.

FIG. 7 is a sectional view taken along line A-A of FIG. 6 according to a number of variations.

FIG. 8A illustrates a gas catcher of an airbag diffuser according to a number of variations.

FIG. 8B illustrates a gas catcher of an airbag diffuser according to a number of variations.

FIG. 9 illustrates an airbag diffuser including a gas catcher constructed and arranged to extend above one end of the body portion of the diffuser according to a number of variations.

FIG. 10 is a sectional view taken along line B-B of FIG. 9 according to a number of variations.

FIG. 11A illustrates a gas catcher for use in the diffuser of FIG. 9 according to a number of variations.

FIG. 11B illustrates a gas catcher for use in the diffuser of FIG. 9 according to a number of variations.

FIG. 12 illustrates an airbag diffuser including a gas catcher in the form of a strap attached to a body portion of the diffuser according to a number of variations.

FIG. 13 is a sectional view taken along line C-C of FIG. 12 according to a number of variations.

FIG. 14 illustrates an airbag diffuser including a gas catcher in the form of straps extending from a body portion of the diffuser and joined together according to a number of variations.

FIG. 15 is a sectional view taken along line D-D of FIG. 14 according to a number of variations.

FIG. 16 illustrates an airbag diffuser including a first opened and a second closed end and having a through hole according to a number of variations.

FIG. 17 illustrates an airbag diffuser having an open end and a closed second end and having a first through hole and a vent hole according to a number of variations.

FIG. 18 illustrates an airbag diffuser including an open end and a second closed end and a first through hole and a second through hole formed therein according to a number of variations.

FIG. 19 illustrates an airbag diffuser including an open end and a second closed end, a first through hole, a second through hole and a vent hole formed therein according to a number of variations.

FIG. 20 illustrates a product including an airbag diffuser received in an airbag cushion according to a number of variations.

FIG. 21 is a perspective view of an airbag cushion inflated between a driver and a console in which an airbag diffuser is received according to a number of variations.

FIG. 22 is another perspective view of the airbag cushion of FIG. 21 according to a number of variations.

FIG. 23 is a side elevation view of an inflated airbag cushion of FIG. 21 according to a number of variations.

### DETAILED DESCRIPTION OF ILLUSTRATIVE VARIATIONS

The following description of variations is merely illustrative in nature and in no way is intended to limit the invention, its application or uses.

One variation may include a product including an airbag diffuser that may be elongated and may be constructed and arranged to provide a gas catcher constructed and arranged to maintain the diffuser in an extended position when hot gases from an inflator impinge on the gas catcher. The gas catcher may be constructed and arranged to prevent the diffuser from telescoping down onto or over the inflator as a result of the reaction forces imparted by the inflator gases on the rest of the diffuser and to prevent the inflator from discharging hot gases directly onto a surrounding airbag cushion and damaging the airbag cushion.

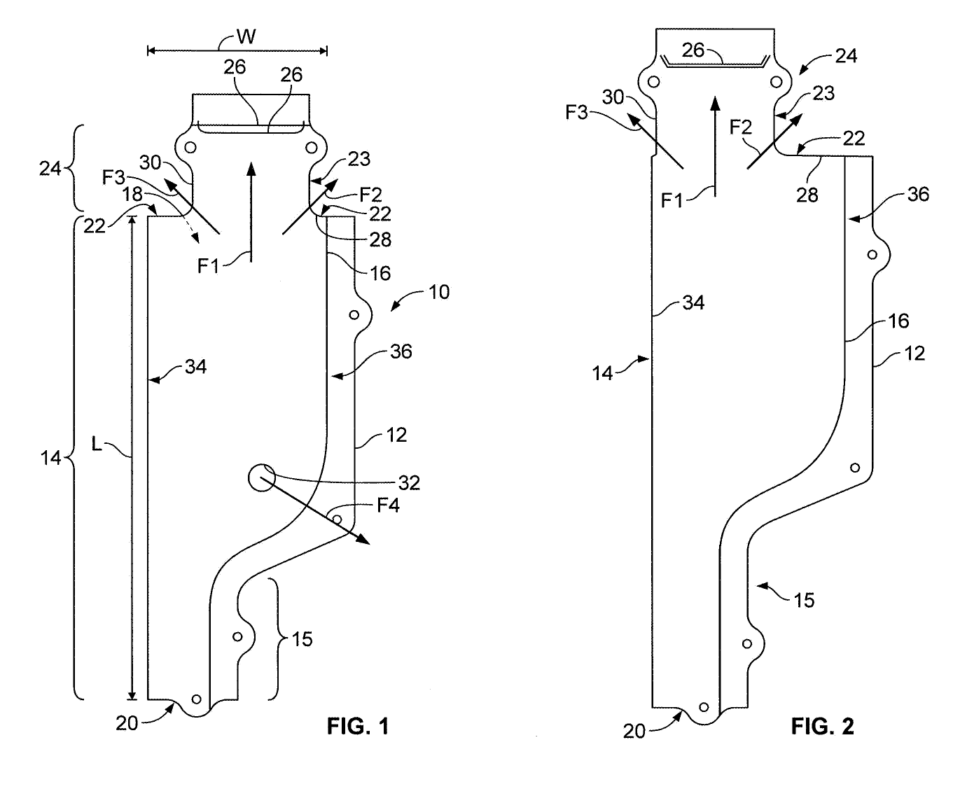

Referring to FIG. 1, one variation may include a product including a parachute airbag diffuser 10 which may include one or more materials 12 that may be constructed and arranged to define an elongated diffuser. The materials 12 may be of any suitable type including, but not limited to fabrics made from natural or synthetic materials including carbon fibers, polymeric fibers, composite fibers and the like which may be woven or nonwoven. In one variation, the diffuser 10 may be a single piece without any seams. In another variation, the diffuser 10 may include a body portion 14. In one variation the material 12 may be a single piece folded over on itself and wherein overlapping portions are connected or joined together. For example, a stitch or sew line, or line of connection 16 may be provided near the edge of overlapping portions to define an inner cavity 18 and an opened end 20. In some variations, the line of connection 16 may be provided by an adhesive bonding overlapping portion or portions may be melted or fused together. The open end 20 may be constructed and arranged to receive an entire inflator (described hereafter) or portion thereof. In another variation, the open end 20 may be constructed and arranged and positioned to receive gases discharged from the inflator. In one variation, a neck portion 15 may be provided in the body portion 14 and may be wrapped around an inflator. External clamps may be used to fasten the neck portion 15 around the inflator. One or more of these clamps may also be used to fasten the neck portion to the airbag cushion. The body portion 14 may have a second end 22 positioned generally opposite to the opened end 20. The inner cavity 18 may be elongated having a length L which is longer than its width W. In one variation, a gas catcher 23 may be provided. In one variation, the gas catcher 23 may include a parachute portion 24 that may extend from, be connected to or attached to the body portion 14.

In one variation, the single piece of material 12 may be folded over on itself and overlapping portions may be connected or joined together using a second sew line or line of connection 26. In one variation, the body portion 14 and/or the parachute portion 24 may include or define one or more through holes in one or both sides of the diffuser. That is, in one variation, at least one of the through holes 28, 30, 32, may be provided in only one layer of the material 12 when the diffuser 10 includes two layers of overlapping material 12. In another variation, at least one of the through holes 28, 30, 32, may go through both layers of material 12 positioned in an overlapping relationship. In one variation, a first hole or through hole 28 may be provided and may, for example, be located generally along the elongated side of the diffuser near the second end 22 of the body portion 14. A second through hole 30 made also be provided and, for example, may be positioned along an opposite elongated side of the body portion 14 near the second end 22 thereof. If desired, in another variation, a third through hole 32 may be provided. In one variation, the third through hole 32 may be positioned in the body portion 14 at a location closer to the neck portion 15 or opened end 20 than to the second end 22 of the body portion 14.

In one variation, the diffuser 10 may be constructed and arranged to provide a gas catcher 23. The gas catcher 23 may be constructed and arranged to maintain the diffuser 10 in an extended position when hot gases from an inflator impinge on the gas catcher 23. The gas catcher 23 may be constructed and arranged to prevent the diffuser from telescoping down onto or over the inflator (describer hereafter) and to prevent the inflator from discharging hot gases directly onto a surrounding airbag cushion (described hereafter) and damaging the airbag cushion.

In one variation, the gas catcher 23 may be constructed and arranged to provide a parachute portion 24 constructed and arranged so that hot gases from the inflator flow in the direction indicated by line F1 so that the parachute portion 24 acts as a gas catcher causing the diffuser end to stay extended to protect the airbag cushion (described hereafter) from the inflator gases. In one variation, gases from the inflator may exit the diffuser through the first through hole 28 as indicated by line F2, through the second through hole 30 as indicated by the line F3 and through the third through hole 32 as indicated by line F4.

In one variation, the parachute portion 24 may be positioned between a first long edge 34 of the body portion and a second long edge 36 of the body portion 14. In one variation the parachute portion may be generally centered and spaced a distance from each of the first long side 34 and second long side 36 of the body portion 14.

Referring now to FIG. 2, in another variation the parachute portion 24 may be positioned closer to the first long side 34 than to the second long side 36. A first through hole 28 and second through hole 30 may be provided. In one variation, the second through hole 30 may be provided in the parachute portion 24 or in the body portion 14 near the second end 22 of the body portion 14. The second through hole 30 may be located in proximity to the first long side 34. If desired, in another variation, a third through hole 32 (not illustrated) may be provided. In one variation, the third through hole 32 may be positioned in the body portion 14 at a location closer to the neck portion 15 or opened end 20 than to the second end 22 of the body portion 14.

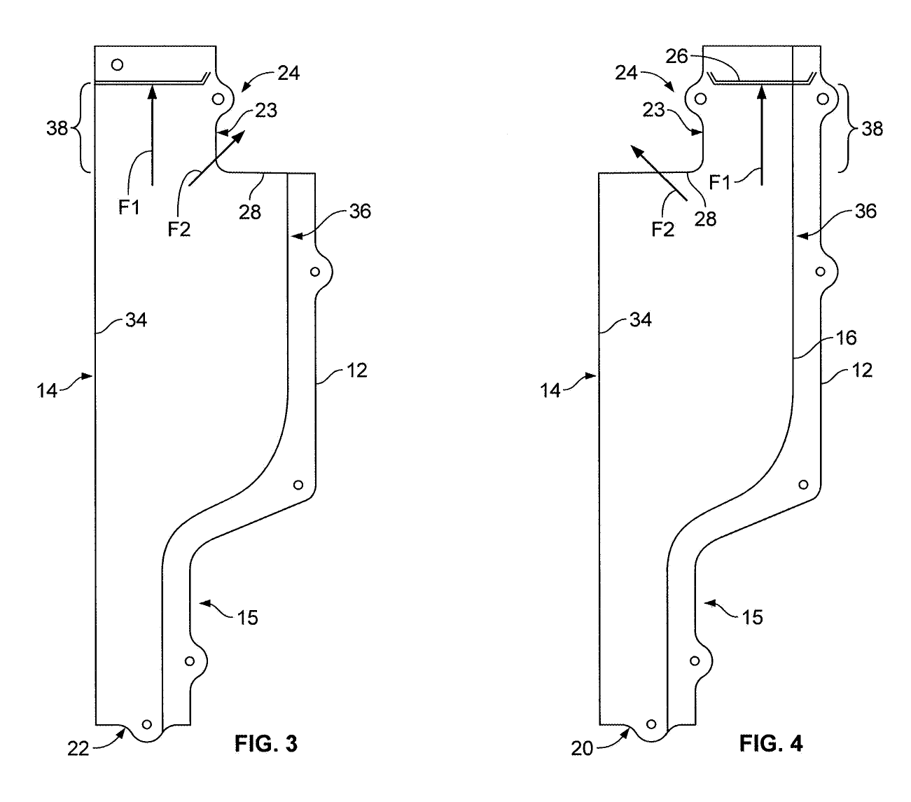

Referring now to FIG. 3, in yet another variation, the parachute portion 24 may be positioned along the first long side 34 of the body portion 14 and may have a closed side 38 so that the parachute portion 24 and/or the body portion 14 define or have the first through hole 28. In this case, when the inflator gas reacts off of the parachute portion 24, it would exit only on one side of the parachute, via the first through hole 28.

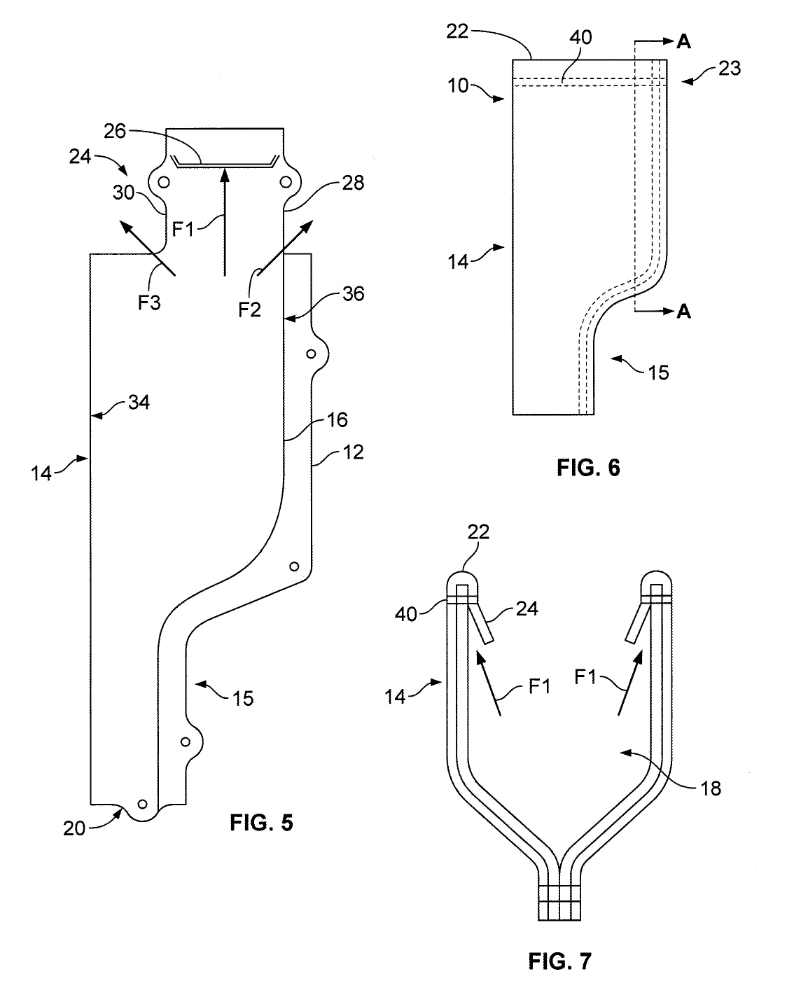

Referring now to FIG. 4, in another variation, the parachute portion 24 may be aligned with the second long side 36 of the body portion 14 and may have a closed side 38 and so that the parachute portion 24 and/or the body portion 14 includes a first through-hole 28. In this case, when the inflator gas reacts off of the parachute portion 24, it would exit only on one side of the parachute, via the first through-hole 28. Referring now to FIG. 5, in another variation, the parachute portion 24 may be aligned with the second long side 36 of the body portion 14 and so that the parachute portion 24 and/or the body portion 14 define or have the first through hole 28 and the second through hole 30. The first through-hole 28 may be located in proximity to the second long side 36. In another variation, it may be possible to reverse the geometry (not illustrated) so that the parachute portion includes an open edge along the first long side 34.

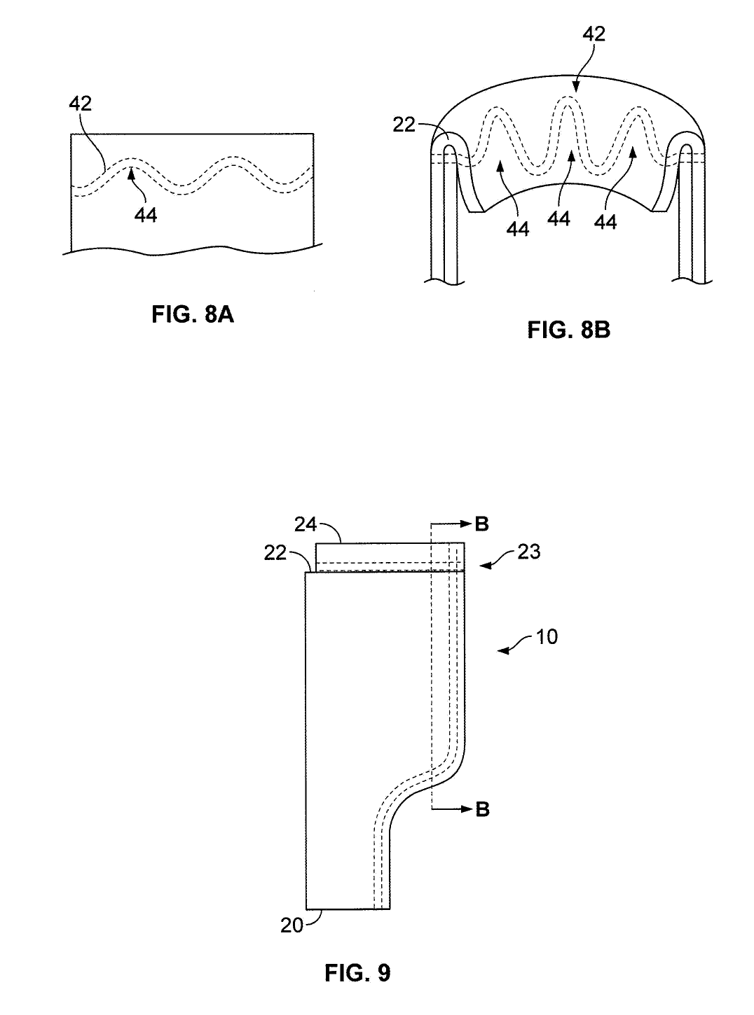

Referring now to FIGS. 6-7, in another variation, the diffuser 10 may include a parachute portion 24 and may be constructed and arranged to extend downward into the inner cavity 18 of the diffuser 10 when the diffuser 10 is not inflated. In one variation, the parachute portion 24 may be constructed and arranged so that the parachute portion 24 does not extend above the second end 22 of the body portion 14 when hot gases from the inflator are impinging on the parachute portion 24. Referring to FIG. 7, a sew line 40 may run around the perimeter of the diffuser body portion 14. The outer layer of the diffuser 10 may be folded over with an end inside the diffuser body 14 and the sew line 40 creates a parachute portion 24 that runs around the internal circumference of the diffuser body 14. Inflator gases represented by the arrows will impinge on the parachute portion 24 and react against the region below the sew line 40. Gases may exit through an opening that may be provided in the parachute portion 24. The opening in the parachute portion 24 may be centrally located with respect to the parachute portion 24. Referring to FIGS. 8A and 8B, in one variation, the parachute portion 24 may be attached to the body portion 14 to have a wavy or sinusoidal profile in sew line 42 to provide a plurality of pockets or concaved cavities 44 around the internal circumference of the diffuser body 14. Such an arrangement is believed to enhance the ability of the pockets 44 to withhold gas and thus to enhance the ability of the diffuser 10 to stay extended to protect the airbag cushion from inflator gases and to prevent the diffuser 10 from telescoping down onto or around the inflator thereby exposing the airbag cushion to direct impact by the hot gases being expelled from the inflator.

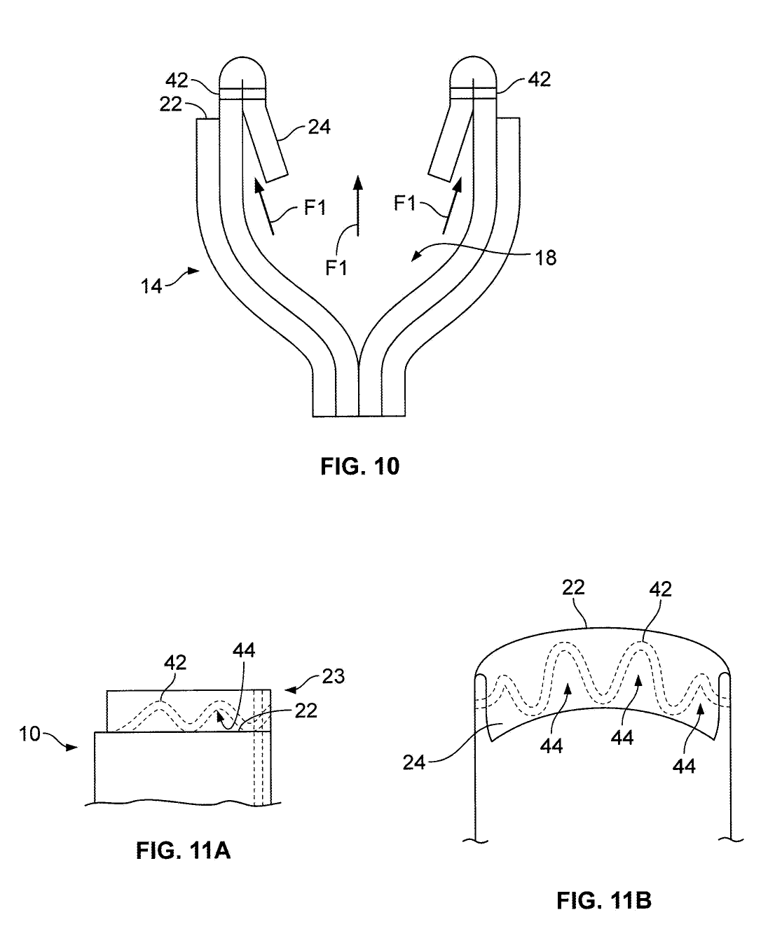

Referring now to FIGS. 9-10, in one variation, the parachute portion 24 may be constructed and arranged to extend into the inner cavity 18 of the body portion 14 but so that the parachute portion 24 is formed using the inner layer of fabric that is utilized to construct the parachute diffuser. The sew line 42 may optionally be located above the other layers of fabric, or in another variation, the sew line 42 may be located adjacent to the other layers of fabric (not illustrated). The parachute portion 24 functions as described for FIGS. 6 and 7. Referring to FIGS. 11A and 11B, the wavy or sinusoidal portion may also be formed using the inner layer of fabric that is utilized to construct the parachute diffuser 24. The parachute portion functions as described for FIGS. 8A and 8B.

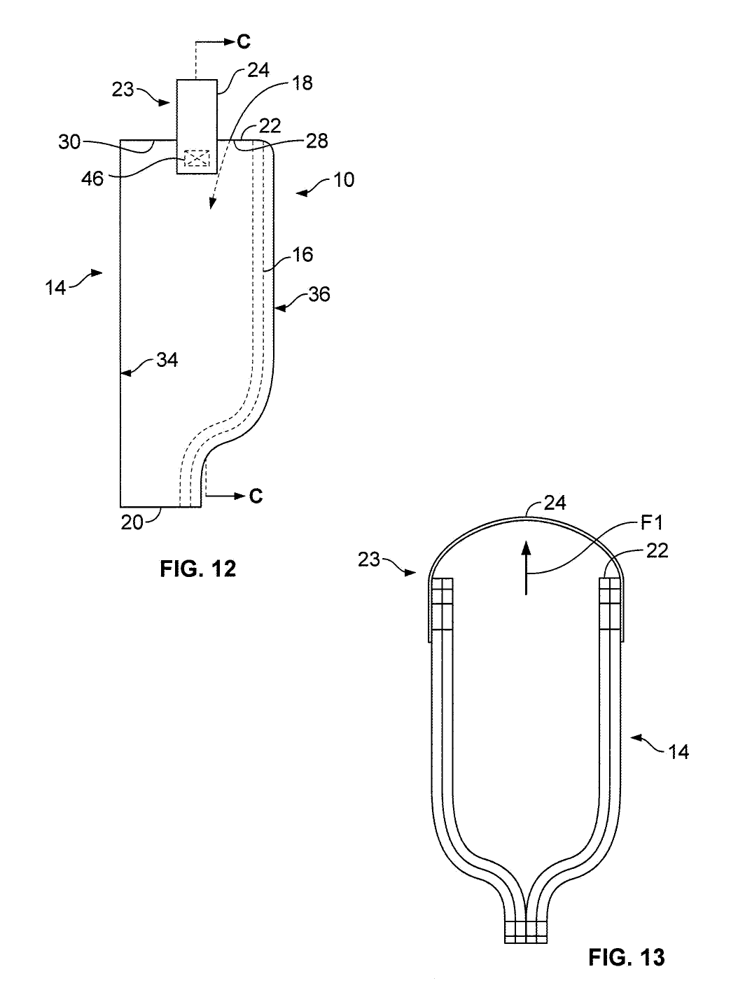

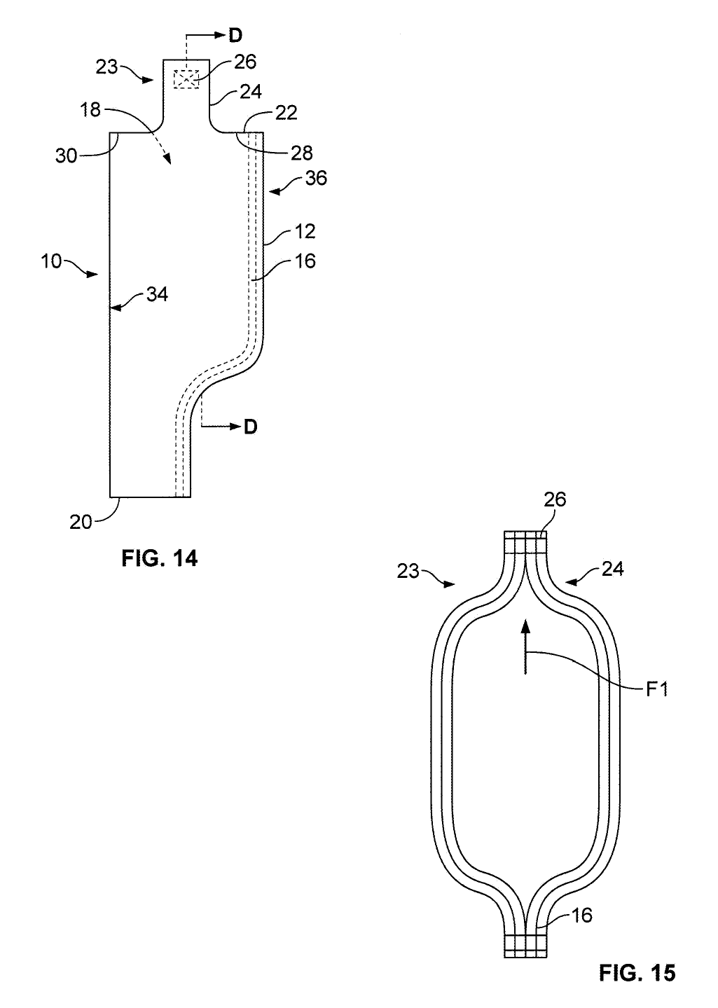

Referring now to FIGS. 12-15, in one variation, the diffuser 10 may include a gas catcher 23 constructed and arranged as a parachute portion 24 in the form of a strap extending above the second end 22 of the body portion 14. In one variation, a fourth sew line or line of connection 46 may be provided to attach the strap shaped parachute portion 24 to the body portion 14. The strap shaped parachute portion 24 may be constructed and arranged to extend above the second end 22 of the body portion 14 when hot gases from the inflator impinge on the parachute portion 24. In one variation, the strap shaped parachute portion 24 may extend from the body portion 14 so as to provide the first through hole 28 and a second through hole 30 through which hot gases from the inflator may exit the diffuser 10.

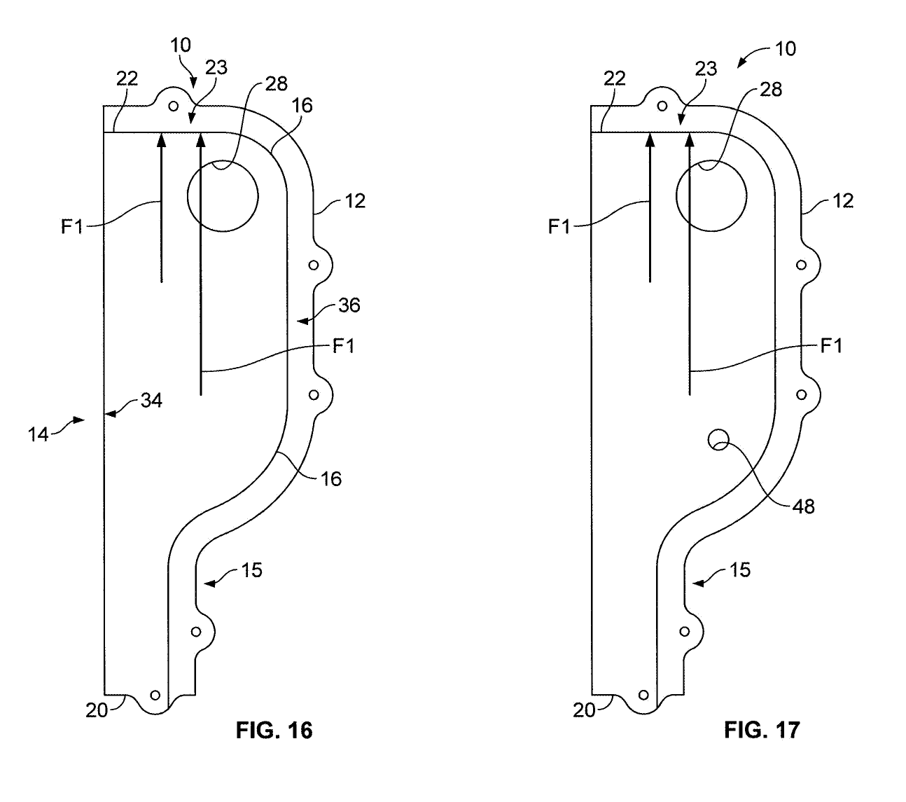

Referring now to FIG. 16, in one variation, the diffuser 10 may include a material folded over on itself along a first side 34 and the overlapping portions may be joined or connected together by a first sew line or line of connection 16 extending along a second long side 36 of the diffuser 10 and along the second end 22 of the body portion 14 so that the second end 22 is closed and defines a gas catcher 23 at the opposite end of the open end 20 of the diffuser 10. A first through hole 28 may be provided in the material 12 through one or both sides of the diffuser 10 and may be positioned near the second end 22 of the body portion 14. Hot gases from the inflator may flow as indicated by arrows F1 and impinge upon the gas catcher 23 defined at the closed end 22 of the diffuser 10. Hot gases from the inflator may exit the diffuser 10 through the first through-hole 28. In another variation, (not illustrated) the diffuser may comprise separate pieces that may be sewn or mechanically attached at the first edge 34 instead of a single piece that may be folded over at the first edge 34. The stitch or mechanical attachment may run continuously around the left side, top side, and right side of the diffuser. Referring now to FIG. 17, in another variation, at least one through-hole 48 may be provided at a location closer to the neck portion 15 of the diffuser 10 than toward the second end 22 of the diffuser 10. Hot gases from the inflator may also exit the through-hole 48 and may assist in filling a lower portion of the airbag cushion (described hereafter).

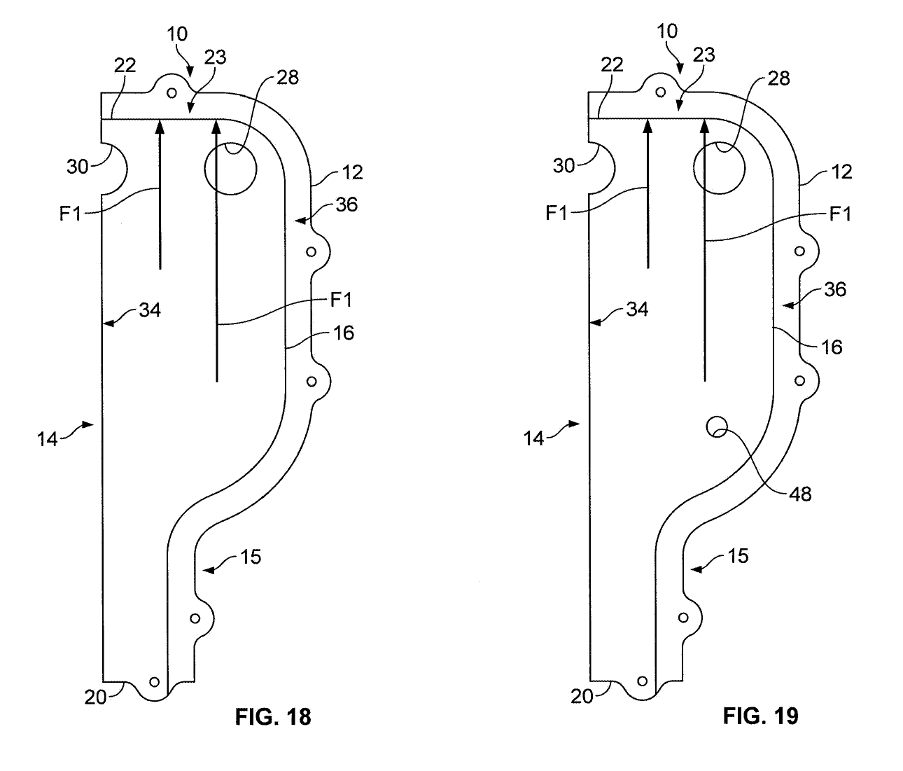

Referring now to FIG. 18, in another variation, in addition to the first through-hole 28, a second through hole 30 may be provided along the first long side 34 near the closed second end 22 of the diffuser 10.

Referring now to FIG. 19, in another variation, in addition to the first through hole 28 and the second through hole 30, another through hole 48 may be provided in the material 12 of the diffuser 10 at a location closer to the neck portion 15 of the diffuser 10 than towards the closed second end 22 of the body portion 14.

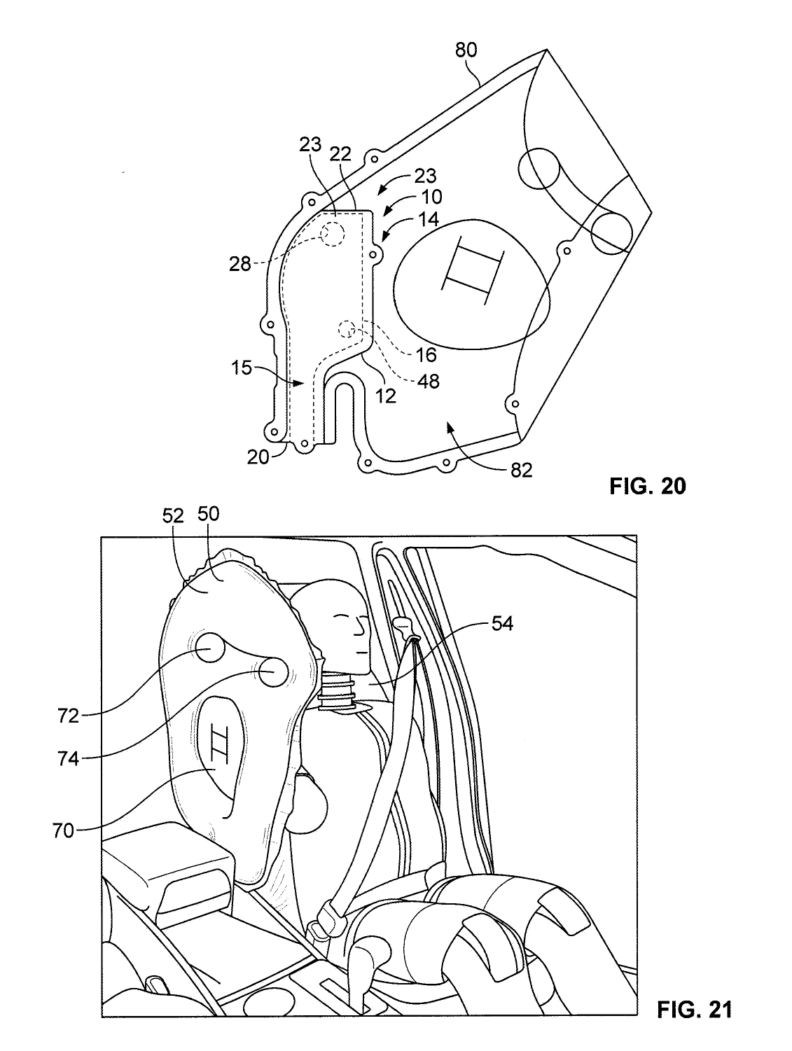

Referring now to FIG. 20, in one variation, the diffuser 10 may be positioned inside of an airbag cushion 50. In one variation, the diffuser 10 may be formed by folding over the material 12 with each side mechanically attached together to provide a closed second end 22 providing a gas catcher 23 opposite the open-end 20 of the diffuser 10. A first sew line or line of connection 16 may be formed along overlapping portions of the material 12 to join or connect the overlapping portions together. A first through hole 28 may be provided near the gas catcher 23. In one variation, the first through hole 28 may be constructed and arranged to primarily direct gas upward around the rearward side of the tubular airbag cushion structure 80. A through hole or vent hole 48 may be provided in the diffuser 10 at a location closer to the neck portion 15 than toward the second end 22 of the body portion 14. In one variation, the vent hole 48 may be constructed and arranged to primarily direct gas forward around the lower portion 82 of the tubular airbag cushion structure 80. It should be understood that the size, quantity, and location of the holes 28, 48 can be changed to control the amount of gas flow to different regions inside the cushion. Any variation of the diffuser 10 may be utilized with the cushion 80 shown in FIG. 20.

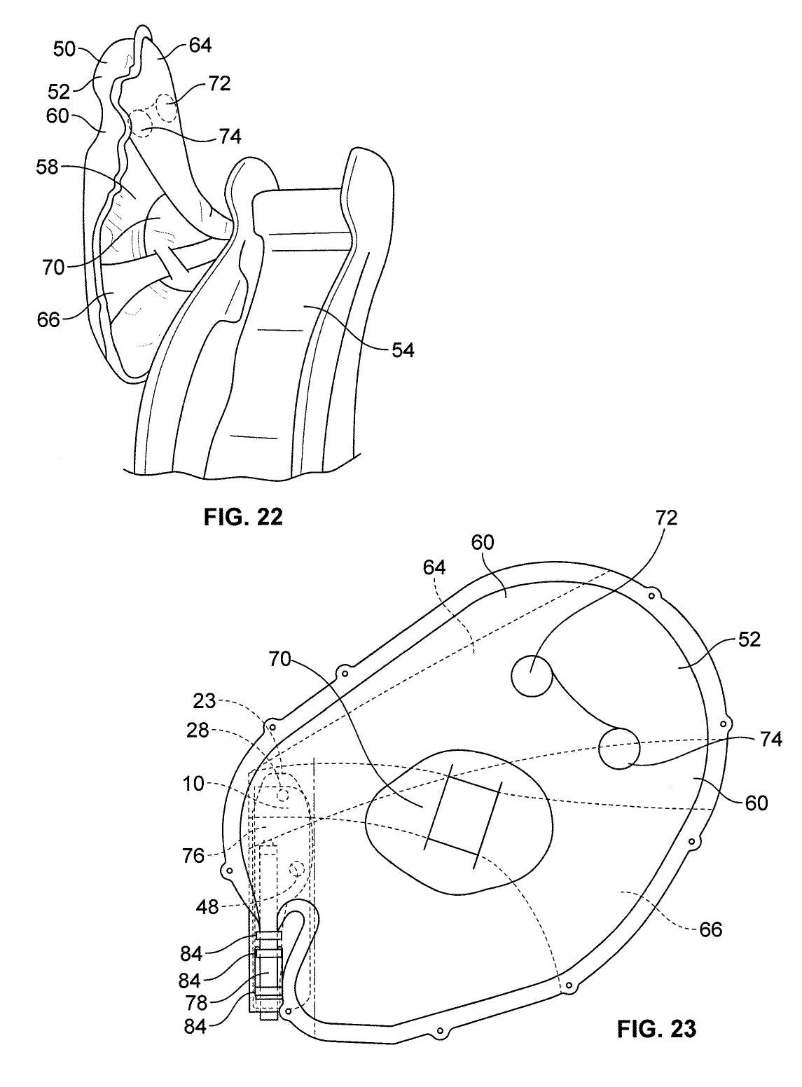

Referring now to FIGS. 21-22, in one variation, the diffuser 10 may be received in a side impact airbag 50 that may have a cushion 52 shown in its inflated condition in FIGS. 21-22 for restraint of a seated occupant. As shown in FIGS. 21-22, the cushion 52 has been inflated and has emerged from a package location, not shown, mounted on the inboard side of the seat back 54 in a vehicle. The diffuser 52 may also be located in a side impact airbag mounted to the outboard side of the seat back 54 (not illustrated). The diffuser 52 may also be located in any of a number of variations of airbags packaged in other regions of the vehicle.

In select variations, the cushion 52 may be constructed from first and second opposite panels of flexible sheet material 12 including an occupant facing panel 58 and an opposite-facing panel 60 facing away from the occupant, for example as illustrated in FIG. 22. An upper 64 and a lower tether 66 may be provided. The occupant facing panel 58 and the opposite-facing panel 60 may be sewn or joined together around their opposite side peripheral edges and may also have additional attachments thereto that may cooperate to define unfilled regions 70, 72 and 74 of the cushion 52. The upper tether 64 and the lower tether 66 may be somewhat shorter in length than the extended length of the occupant facing panel 58 and the opposite-facing panel 60 so that the tethers 64 and 66 may cooperate to rotate the inflating cushion 52 inwardly toward the seated occupant.

Referring now to FIG. 23, in one variation, the airbag cushion 52 is shown in a straight on side view, without the seat back 54. The diffuser 10 may be attached to the airbag cushion 52 and the airbag cushion 52 may be attached to an optional mounting bracket 76 that may be used to mount the cushion 52 on a seat back 54. In one variation, the optional mounting bracket 76 may be generally rectangular in shape and may include rounded corners. The optional mounting bracket 76 may serve as a rigid backbone for the airbag cushion 52 that may be rolled or folded to lay generally on top of the mounting bracket 76 in an uninflated condition. The diffuser 10, airbag cushion 52, and inflator 78 may be attached to the optional mounting bracket 76 via clamps 84. At least one of the clamps 84 (likely the top one) may attach the diffuser 10 to the inflator 52 and optionally the airbag cushion 52 which may provide a robust gas seal at the clamp location. The inflator 78 may include a charged material that may be electronically ignited causing hot gases to expel from a nozzle of the inflator 78 which may in turn fill the diffuser 10 and then may fill the airbag cushion 52 as the gas passes through holes 28, 48, and 30 if present. The gas catcher 23 portion of the diffuser 10 may be propelled upward by the impinging gas from the inflator 78 and may hold the diffuser 20 upward during the deployment so that it does not fall downward near the nozzle which may expose the cushion 52 to direct impingement of the gas from the inflator 78 through at least on of holes 28, 48, and 30 if present. The optional mounting bracket 76 with the inflator 78, airbag cushion 52 and diffuser 10 may be installed in the seat back 54 and concealed within the seat back cushion 54.

The diffuser may be fabricated out of multiple pieces or multiple layers of fabric to shape and strengthen it where needed and not deviate from the spirit and scope of the invention. In addition, it may be possible to tuck the parachute portion 24 down inside the diffuser body portion 14 prior to inflator deployment. Finally, in select variations, the diffuser 10 may be utilized in cushion constructions that are non-tubular designs, such as a cushion that has one single large chamber or two chambers.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: an elongated airbag diffuser comprising a body portion and including a gas catcher near a perimeter end of the diffuser constructed and arranged to be impinged by gases from an inflator causing the diffuser to stay in an extended position.

Variation 2 may include a product as set forth in Variation 1 wherein the gas catcher comprises a strap of material that extends outside the body portion and is attached to opposite sides of the body portion around a gas opening.

Variation 3 may include a product as set forth in Variation 2 wherein the strap is located near the center of the gas opening.

Variation 4 may include a product as set forth in any of Variations 2-3 wherein the strap is located at an edge of the gas opening.

Variation 5 may include a product as set forth in any of Variations 1-4 wherein the diffuser includes at least one material flap inside the body portion to capture gas.

Variation 6 may include a product as set forth in Variation 5 wherein the at least one material flap is attached to the body portion in a manner to form at least one concave cavity to capture gas.

Variation 7 may include a product as set forth in any of Variations 1-6 wherein the gas catcher is provided in the material of the diffuser at a location above at least one hole in the diffuser.

Variation 8 may include a product as set forth in Variation 7 wherein the at least one hole in the diffuser is positioned to direct the gas in one direction inside a tubular airbag structure.

Variation 9 may include a product as set forth in any of Variations 1-8 wherein a through hole is provided to direct the gas to a region of an airbag cushion.

Variation 10 may include a product as set forth in any of Variations 1-9 further comprising an air bag cushion and wherein the diffuser is received in the airbag cushion.

Variation 11 may include a product as set forth in any of Variations 1-9 wherein the diffuser includes a first opening therein to direct the gas towards a first region of an airbag cushion and further comprising a vent hole formed in the diffuser to direct the gas to a second region of the airbag cushion.

Variation 12 may include a product as set forth in any of Variations 1-11 wherein a first through hole is formed in the diffuser on one side of the gas catcher and a second through hole is formed on a second side of the gas catcher.

Variation 13 may include a product as set forth in any of Variations 1-12 wherein the gas catcher is constructed and arranged to divert gas from an inflator directionally as well as to maintain the diffuser in an extended position when gases from the inflator impinge on the gas catcher.

Variation 14 may include a product as set forth in any of Variations 1-13 further comprising an airbag cushion, and wherein the diffuser is received in the airbag cushion, and further comprising a vehicle seat having a seat back, and wherein the airbag cushion, and diffuser are received in the vehicle seat back.

Variation 15 may include a product as set forth in any of Variations 1-14 wherein the body portion has an open end and an opposite closed end and at least one through hole form in the body portion for directing the gas out of the diffuser.

Variation 16 may include a product as set forth in any of Variations 1-15 further comprising an airbag cushion, an inflator having a gas exit nozzle, and wherein the diffuser is received in the airbag cushion, and wherein the inflator is entirely received in the diffuser or at least a portion of inflator is received in the diffuser.

Variation 17 may include a product comprising an elongated airbag diffuser comprising a body portion and a gas catcher, the gas catcher comprising a parachute portion extending from the body portion and constructed and arranged to maintain the diffuser in an extended position when gases from in an inflator impinge upon the parachute portion and to prevent the diffuser from telescoping down around the inflator.

Variation 18 may include a product comprising an airbag cushion, an airbag diffuser received in the airbag cushion, an inflator received in the airbag diffuser and attached thereto, the airbag diffuser comprising a body portion and a gas catcher, the gas catcher comprising a parachute portion extending from the body portion of the diffuser and constructed and arranged to maintain the diffuser in an extended position when gases from the inflator impinge upon the parachute portion and to prevent the diffuser from telescoping down around the inflator.

Variation 19 may include a product as set forth in Variation 18 wherein the parachute portion comprises a strap extending from the body portion.

Variation 20 may include a product as set forth in Variation 19 wherein the strap provides a first opening on one side of the strap and a second opening on a second side of the strap.

Variation 21 may include a product comprising an elongated airbag diffuser comprising a body portion and a gas catcher constructed and arranged to be impinged by gases from an inflator causing the diffuser to stay in an extended position.

Variation 22 may include a product as set forth in Variation 21 wherein the body portion has an open end and an opposite second end, and wherein the gas catcher is positioned below the opposite second end of the body portion.

Variation 23 may include a product as set forth in any of Variations 21-22 wherein the body portion has an open end and an opposite second end, and a hole formed in the body portion, and wherein the gas catcher is positioned below the opposite second end of the body portion and above the hole.

Variation 24 may include a product as set forth in any of Variations 21-23 wherein the gas catcher comprises a strap.

Variation 25 may include a product as set forth in Variation 24 wherein the strap and the body portion are constructed and arranged to provide at least one hole adjacent the strap.

Variation 26 may include a product as set forth in any of Variations 24-25 wherein the strap and the body portion are constructed and arranged to provide a first hole adjacent one side of the strap and a second hole adjacent another opposite side of the strap.

Variation 27 may include a product as set forth in any of Variations 24-26 wherein the strap is aligned with one long side of the body portion.

Variation 28 may include a product as set forth in any of Variations 24-27 wherein the strap includes a first end and a second end and wherein the strap is attached to the body portion by a line of connection at the first end and by another line of connection at the second end of the strap.

Variation 29 may include a product as set forth in any of Variations 24-28 wherein the strap comprises a first flap extending from the body portion and a second flap extending from the body portion, wherein the first flap and the second flap are attached to each other by a line of connection to form the strap.

Variation 30 may include a product as set forth in Variation 21 wherein the body portion has an open end and an opposite second end, wherein the gas catcher comprises a strap and at least one hole formed defined by at least one of the body portion and the strap.

Variation 31 may include a product as set forth in any of Variations 21 or 30 wherein the body portion has an open end and an opposite second closed end, wherein the gas catcher comprises at least a portion of the closed end.

Variation 32 may include a product as set forth in any of Variations 21, 30, or 31 wherein the gas catcher comprises a parachute portion comprising a layer extending into a cavity defined by the body portion, wherein the parachute portion runs around the internal circumference of the diffuser body portion and is constructed and arranged so that the gases impinge upon the parachute portion causing the diffuser to stay in an extended position.

Variation 33 may include a product as set forth in Variation 32 wherein the parachute portion has an opening therethrough to allow gases from the inflator to exit the diffuser.

Variation 34 may include a product as set forth in any of Variations 32-33 further comprising a wavy or sinusoid line of connection defining a plurality of cavities in the parachute portion.

Variation 35 may include a product as set forth in Variation 21 further comprising a wavy or sinusoid line of connection.

Variation 36 may include a product as set forth in any of Variations 1-35 further comprising an inflator inserted into an opening in the diffuser.

Variation 37 may include a product as set forth in Variation 36 further comprising a clamp which clamps the inflator and diffuser together.

Variation 38 may include a product as set forth in Variation 36 further comprising a clamp which clamps the inflator, diffuser, and cushion together.

The above description of select variants is merely illustrative in nature and, thus, variations or variants of the examples including components, elements, acts thereof and variations of the select combinations are not to be regarded as a departure from the spirit and scope of the invention.

What is claimed is:

1. A product comprising: an elongated airbag diffuser comprising a body portion and including a gas catcher near a perimeter end of the diffuser constructed and arranged to be impinged by gases from an inflator causing the diffuser to stay in an extended position.

2. A product as set forth in claim 1 wherein the gas catcher comprises a strap of material that extends outside the body portion and is attached to opposite sides of the body portion around a gas opening.

3. A product as set forth in claim 1 wherein the strap is integral with the body portion.

4. A product as set forth in claim 2 wherein the strap is located near the center of the gas opening.

5. A product as set forth in claim 2 wherein the strap is located at an edge of the gas opening.

6. A product as set forth in claim 2 wherein the diffuser includes at least one material flap inside the body portion to capture the gas.

7. A product as set forth in claim 6 wherein the at least one material flap is attached to the body portion in a manner to form at least one concave cavity to capture the gas.

8. A product as set forth in claim 1 wherein the gas catcher is provided in a material of the diffuser at a location above at least one hole in the diffuser.

9. A product as set forth in claim 8 wherein the at least one hole in the diffuser is positioned to direct the gas in one direction inside a cushion.

10. A product as set forth in claim 1 further comprising an airbag cushion and wherein the diffuser is received in the airbag cushion.

11. A product as set forth in claim 1 wherein the diffuser includes a first opening therein to direct the gas towards a first region of an airbag cushion and further comprising a vent hole formed in the diffuser to direct the gas to a second region of the airbag cushion.

12. A product as set forth in claim 1 wherein the gas catcher is constructed and arranged to divert the gas from an inflator directionally as well as to maintain the diffuser in an extended position when the hot gases from the inflator impinge on the gas catcher.

13. A product as set forth in claim 1 further comprising an airbag cushion, and wherein the diffuser is received in the airbag cushion, and further comprising a vehicle seat having a seat back, and wherein the airbag cushion, and diffuser are received in the vehicle seat back.

14. A product as set forth in claim 1 wherein the body portion has an open end and an opposite closed end and at least one through hole formed in the body portion for directing the gas out of the diffuser.

15. A product as set forth in claim 1 further comprising an airbag cushion, an inflator having a gas exit nozzle, and wherein the diffuser is received in the airbag cushion, and wherein the inflator is entirely received in the diffuser or at least a portion of inflator is received in the diffuser.

16. A product comprising an elongated airbag diffuser comprising a body portion and a gas catcher, the gas catcher comprising a parachute portion extending from the body portion and constructed and arranged to maintain the diffuser in an extended position when gases from in an inflator impinge upon the parachute portion and to prevent the diffuser from telescoping down around the inflator.

17. A product comprising an airbag cushion, an airbag diffuser received in the airbag cushion, an inflator received in the airbag diffuser and attached thereto, the airbag diffuser comprising a body portion and a gas catcher, the gas catcher comprising a parachute portion extending from the body portion of the diffuser and constructed and arranged to maintain the diffuser in an extended position when gases from the inflator impinge upon the parachute portion and to prevent the diffuser from telescoping down around the inflator.

18. A product as set forth in claim 18 wherein the parachute portion comprises a strap extending from the body portion.

19. A product as set forth in claim 19 wherein the strap provides a first opening on one side of the strap and a second opening on a second side of the strap.

20. A product comprising an airbag cushion, an airbag diffuser received in the airbag cushion, an inflator received in the airbag diffuser and attached thereto, the airbag diffuser comprising a body portion and a gas catcher, the gas catcher comprising a closed portion at a top of the body portion of the diffuser and at least one hole in the diffuser body which is constructed and arranged to direct gas, wherein the diffuser is constructed and arranged to maintain an extended position when gases from the inflator impinge upon the gas catcher portion and to prevent the diffuser from telescoping down around the inflator.
